(19) United States
(12) Patent Application Publication
(10) Pub. No.: US 2026/0212101 A1
(43) Pub. Date: Jul. 23, 2026

(54) CIRCUIT CONFIGURATION DEVICE AND METHOD

(71) Applicant: ASUSTeK COMPUTER INC., Taipei City (TW)

(72) Inventors: Hsi-Ho Hsu, Taipei City (TW); Hsiang-Jui Hung, Taipei City (TW); Wei-Gen Chung, Taipei City (TW); Chun-San Lin, Taipei City (TW); Yu-Kai Yeh, Taipei City (TW); Chang-Tsai Tsai, Taipei City (TW); Yu-Xuan Du, Taipei City (TW); Bo-Siang Cheng, Taipei City (TW)

(73) Assignee: ASUSTeK COMPUTER INC., Taipei City (TW)

(21) Appl. No.: 19/449,457

(22) Filed: Jan. 15, 2026

(30) Foreign Application Priority Data
Jan. 22, 2025 (TW) 114102878

(51) Int. Cl. G06F 30/367; G06F 30/392; G06F 119/06

(52) U.S. Cl. CPC G06F 30/367; G06F 30/392; G06F 2119/06

(57) ABSTRACT

Provided are a circuit configuration device and a circuit configuration method. The method is applicable to a buck circuit and including the following steps: evaluating an inductance range suitable for the buck circuit according to a design specification of the buck circuit; testing multiple efficiency curves respectively corresponding to multiple inductance values in the inductance range according to the design specification and the inductance range; analyzing the efficiency curves to obtain one or more efficiency curve intersection points; planning an inductor region to be configured on the buck circuit according to the inductance range and the efficiency curve intersection point. The inductor region includes one or more inductor groups. Each inductor group is formed by packaging after series connection of multiple inductor elements. The circuit inductance formed by the inductor region varies with a state of the buck circuit.

### CROSS-REFERENCE TO RELATED APPLICATION

This application claims the priority benefit of Taiwan application serial no. 114102878, filed on Jan. 22, 2025. The entirety of the above-mentioned patent application is hereby incorporated by reference herein and made a part of this specification.

### BACKGROUND

### Technical Field

This disclosure relates to a circuit configuration device and a method that may improve circuit efficiency.

### Description of Related Art

As current energy regulations for electronic products become increasingly stringent year by year, energy conservation has become an important design concept. Existing electronic products often switch between light-load and heavy-load states according to usage scenarios. However, current circuit designs may only improve energy consumption for a single state.

### SUMMARY

The disclosure provides a circuit configuration device applicable for configuring a buck circuit. The circuit configuration device includes a storage device and a circuit configuration processor. The storage device is configured to store a design specification of the buck circuit. The circuit configuration processor is coupled to the storage device and is configured to load the design specifications to execute the following steps of: evaluating an inductance range suitable for the buck circuit according to the design specification; testing multiple efficiency curves respectively corresponding to multiple inductance values in the inductance range according to the design specification and the inductance range; analyzing the efficiency curves to obtain one or more efficiency curve intersection points; and planning an inductor region to be configured on the buck circuit according to the inductance range and the one or more efficiency curve intersection points. The inductor region includes one or more inductor groups. Each inductor group is formed by packaging after series connection of multiple inductor elements. A circuit inductance formed by the inductor region varies with a state of the buck circuit.

The disclosure also provides a circuit configuration method applicable to a buck circuit. The circuit configuration method includes the following. According to a design specification of the buck circuit, an inductance range suitable for the buck circuit is evaluated. According to the design specification and the inductance range, multiple efficiency curves respectively corresponding to multiple inductance values in the inductance range are tested. The efficiency curves are analyzed to obtain one or more efficiency curve intersection points. According to the inductance range and the one or more efficiency curve intersection points, an inductor region to be configured on the buck circuit is planned. The inductor region includes one or more inductor groups. Each inductor group is formed by packaging after series connection of multiple inductor elements. A circuit inductance formed by the inductor region varies with a state of the buck circuit.

Based on the above, the circuit configuration device and method of the disclosure may allow the planned buck circuit to maintain high efficiency values whether in the state of light load or heavy load. As a result, it may simultaneously reduce the energy consumption of the circuit under light load and heavy load, thereby significantly improving circuit efficiency.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram illustrating a circuit configuration device according to an embodiment of the disclosure.

FIG. 2 is a block diagram illustrating a storage device according to an embodiment of the disclosure.

FIG. 3 is a circuit architecture diagram illustrating a buck circuit according to an embodiment of the disclosure.

FIG. 4 is a flowchart illustrating a circuit configuration method according to an embodiment of the disclosure.

FIG. 5 is an example of a curve diagram illustrating efficiency curves according to an embodiment of the disclosure.

FIG. 6A is a relationship diagram illustrating the current value flowing through an inductor region relative to the efficiency value and inductance value according to an embodiment of the disclosure.

FIG. 6B is a relationship diagram illustrating the current value flowing through the inductor region relative to the output voltage according to an embodiment of the disclosure.

FIG. 7A and FIG. 7B are circuit architecture diagrams illustrating buck circuits according to an embodiment of the disclosure.

### DESCRIPTION OF THE EMBODIMENTS

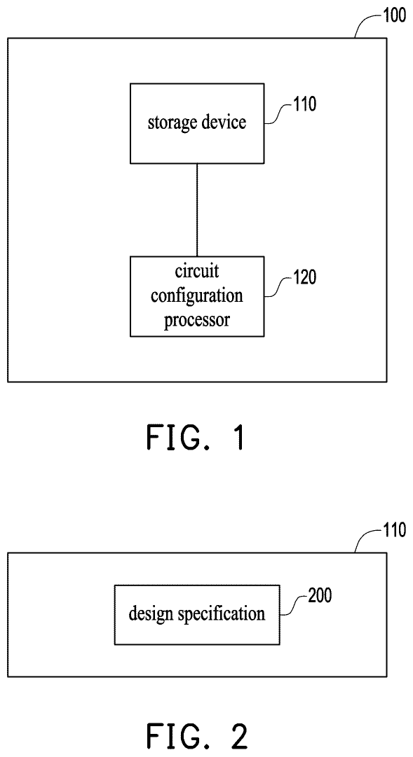

Please refer to FIG. 1. In some embodiments, a circuit configuration device 100 includes but not limited to a personal computer, a smartphone, a Personal Digital Assistant (PDA), a laptop computer, a tablet computer, or a server with a storage device 110 or a circuit configuration processor 120.

In some embodiments, the storage device 110 includes but not limited to any type of fixed or removable Random Access Memory (RAM), Read-Only Memory (ROM), Flash memory, hard disk or similar element, or a combination of the above elements. The storage device 110 is used to store computer programs that can be executed by the circuit configuration processor 120 and the data used by these programs.

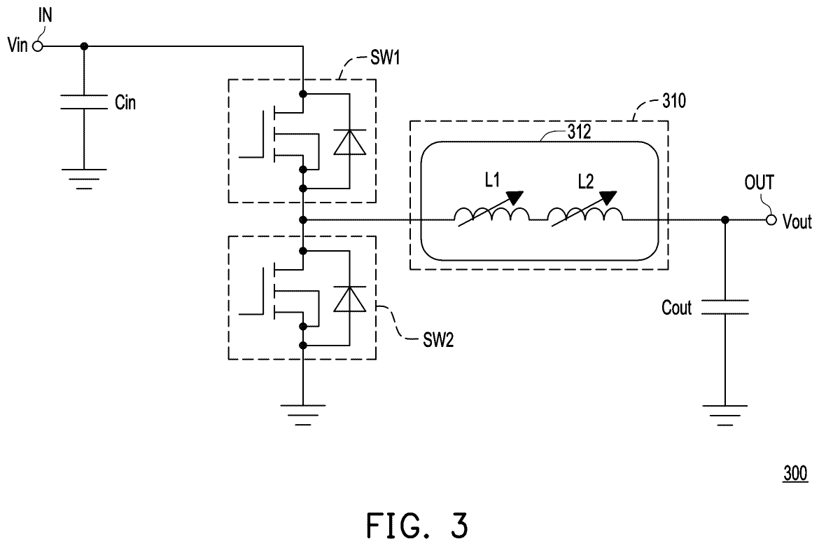

Specifically, as shown in FIG. 2, the storage device 110 stores relevant data for configuring a buck circuit 300, including a design specification 200 of the buck circuit 300. The design specification 200 includes a compilation of circuit design guidelines and rules for the buck circuit 300. The circuit architecture of the buck circuit 300 can be referred to in the following description.

The circuit configuration processor 120 is coupled to the storage device 110. In some embodiments, the circuit configuration processor 120 includes but not limited to a central processing unit, or other programmable general-purpose or special-purpose microprocessor, Digital Signal Processor (DSP), programmable controller, Application Specific Integrated Circuit (ASIC), or other similar elements or a combination of the above elements. In this embodiment, the circuit configuration processor 120 may load the design specification 200 from the storage device 110 to execute a circuit configuration method of the embodiment of the disclosure.

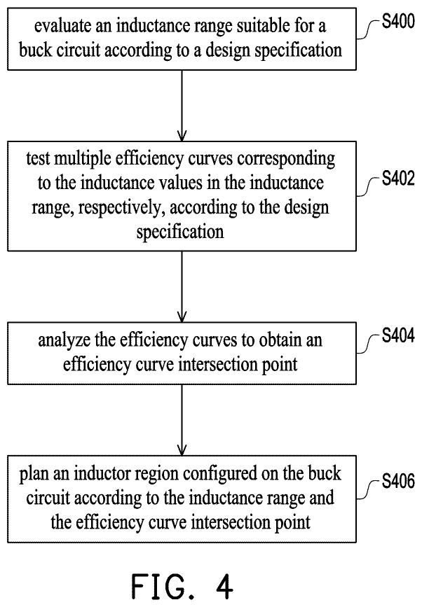

The circuit configuration device of this embodiment of the disclosure may apply to configuring a buck circuit 300 supply power. As shown in FIG. 3, the buck circuit 300 includes an input capacitor Cin, a first switch SW1, a second switch SW2, an inductor region 310, and an output capacitor Cout. The first terminal of the input capacitor Cin is coupled to an input terminal IN of the buck circuit 300, and the second terminal of the input capacitor Cin is grounded. The first terminal of the first switch SW1 is coupled to the input terminal IN of the buck circuit 300. The first terminal of the second switch SW2 is coupled to the second terminal of the first switch SW1, and the second terminal of the second switch SW2 is grounded. The inductor region 310 is coupled between the second terminal of the first switch SW1 and the output terminal OUT of the buck circuit 300. The first terminal of the output capacitor Cout is coupled to an output terminal OUT of the buck circuit 300, and the second terminal of the output capacitor Cout is grounded. The inductor region 310 includes one or more inductor groups (for example, a first inductor group 312), each inductor group is formed by packaging multiple inductor elements (for example, a first inductor element L1 and a second inductor element L2) in series connection. In this embodiment, the specification values of each inductor element within the inductor group are different from each other, so the circuit inductance formed by the inductor region 310 may change with the status of the buck circuit 300. For example, as the current value flowing through the inductor region 310 increases, some inductor elements with larger specification values in the inductor region 310 may gradually convert into resistive elements. Therefore, the circuit inductance under a light load status when the current value flowing through the inductor region 310 is smaller may be greater than the circuit inductance under a heavy load status when the current value flowing through the inductor region 310 is larger.

The input terminal IN of the buck circuit 300 may receive an input voltage Vin provided by a power adapter (for example, an AC adapter, PD adapter, etc.) or a battery. The output terminal OUT of the buck circuit 300 may transmit the output voltage Vout, for example, through a Voltage Regulator to the Central Processing Unit (CPU), Graphics Processing Unit (GPU), and other various system elements on the motherboard. The first switch SW1 and the second switch SW2 may be implemented, for example, as n-type Metal-Oxide-Semiconductor Field-Effect Transistors (NMOSFET), but the disclosure is not limited to this.

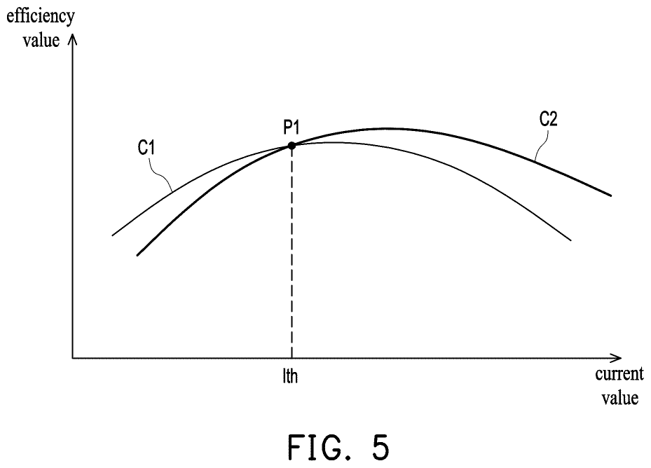

Please refer to FIG. 1 to FIG. 4 simultaneously. The circuit configuration method of this embodiment may apply to the circuit configuration device 100 in FIG. 1, and its steps are described as follows.

First, in step S400, the circuit configuration processor 120 evaluates an inductance range suitable for the buck circuit 300 according to the design specification 200 of the buck circuit 300. For example, the inductance range suitable for the buck circuit 300 may be 0.15 to 0.36 microhenries.

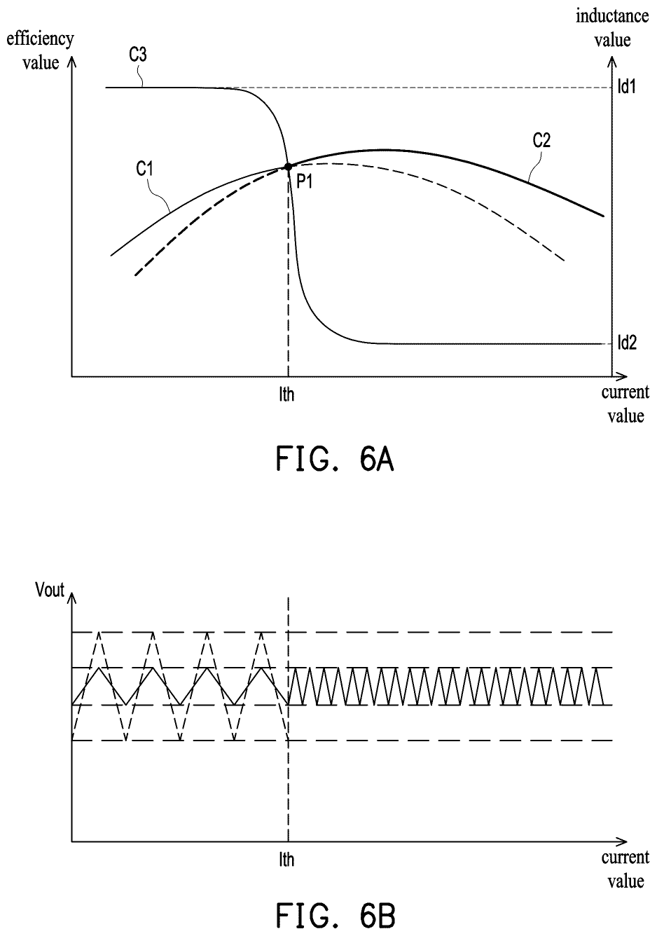

Next, in step S402, the circuit configuration processor 120 tests a first efficiency curve C1 and a second efficiency curve C2 corresponding to the inductance values in the inductance range, respectively, according to the design specification 200 and the inductance range. For example, the first efficiency curve C1 and the second efficiency curve C2 conform to the design specification 200 and correspond to a first inductance Id1 (e.g., 0.36 microhenries) and a second inductance Id2 (e.g., 0.15 microhenries) in the evaluated inductance range suitable for the buck circuit 300, respectively. FIG. 5 illustrates an example of the curve diagram of the first efficiency curve C1 and the second efficiency curve C2, where the horizontal axis of FIG. 5 represents the current value flowing through the inductor region 310, and the vertical axis represents the efficiency value. The first efficiency curve C1 is the curve obtained when configuring the inductor region 310 with the first inductance Id1, and the second efficiency curve C2 is the curve obtained when configuring the inductor region 310 with the second inductance Id2. In this embodiment, the efficiency value is the ratio of the output energy to the input energy of the inductor.

Then, in step S404, the circuit configuration processor 120 analyzes the first efficiency curve C1 and the second efficiency curve C2 to obtain an efficiency curve intersection point P1 of the first efficiency curve C1 and the second efficiency curve C2 as shown in FIG. 5. A current value Ith of the efficiency curve intersection point P1, for example, 10 amperes, may be regarded as the optimal point for switching the circuit inductance.

Finally, in step S406, the circuit configuration processor 120 plans the inductor region 310 to be configured on the buck circuit 300 according to the inductance range of the buck circuit 300 and the efficiency curve intersection point P1. In this embodiment, the planned inductor region 310 includes a first inductor group 312 formed by packaging after series connection of the first inductor element L1 and the second inductor element L2. The specification value (e.g., 0.21 microhenries) of the second inductor element L2 is greater than the specification value (e.g., 0.15 microhenries) of the first inductor element L1.

When the buck circuit 300 is in the state of light load, indicating that a current IL flowing through the inductor region 310 is less than the current value Ith of the efficiency curve intersection point P1 of the first efficiency curve C1 and the second efficiency curve C2, the circuit inductance of the buck circuit 300 equates to the sum of the inductance value of the first inductor element L1 in the first inductor group 312 and the inductance value of the second inductor element L2 in the first inductor group 312 (circuit inductance is high inductance). In other words, the circuit inductance at this time approximately equates to the first inductance Id1 (e.g., 0.36 microhenries) corresponding to the first efficiency curve C1, where the first efficiency curve C1 corresponds to the sum of the inductance value of the first inductor element L1 in the first inductor group 312 and the inductance value of the second inductor element L2 in the first inductor group 312.

When the buck circuit 300 is in the state of heavy load, indicating that the current IL flowing through the inductor region 310 is greater than the current value Ith of the efficiency curve intersection point P1 of the first efficiency curve C1 and the second efficiency curve C2, the second inductor element L2 in the first inductor group 312 converts to a resistive element, and the circuit inductance of the buck circuit 300 equates to the inductance value of the first inductor element L1 in the first inductor group 312. In other words, the circuit inductance at this time approximately equates to the second inductance Id2 (e.g., 0.15 microhenries) corresponding to the second efficiency curve C2, where the second efficiency curve C2 corresponds to the inductance value of the first inductor element L1 in the first inductor group 312.

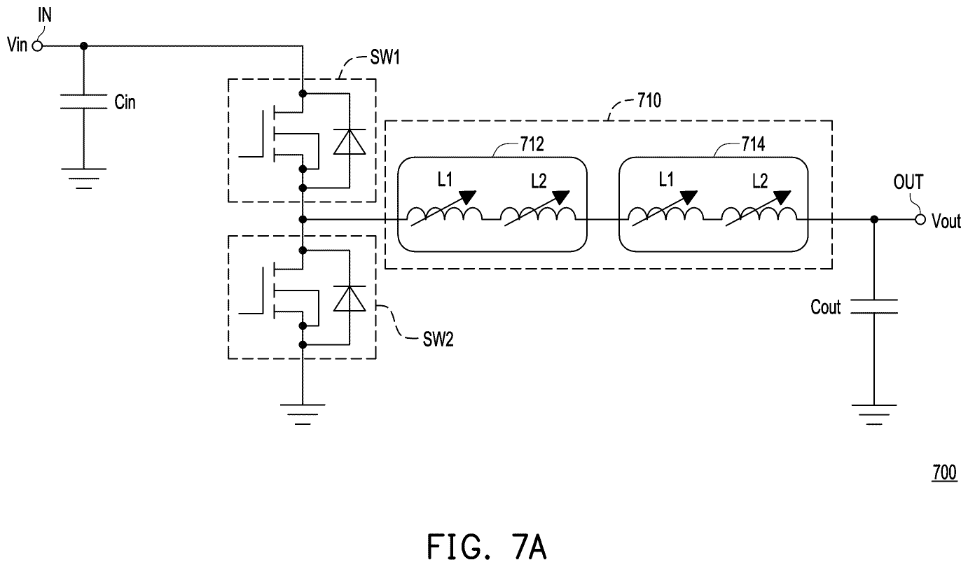

The following example illustrates the technical effect of improving circuit efficiency in this case. The horizontal axis of FIG. 6A represents the current value flowing through the inductor region 310, the vertical axis corresponding to the first efficiency curve C1 and the second efficiency curve C2 is the efficiency value on the left side, and the vertical axis corresponding to a circuit inductance curve C3 of the buck circuit 300 is the inductance value on the right side. When the buck circuit 300 is in the state of light load, indicating that the current IL flowing through the inductor region 310 is less than the current value Ith of the efficiency curve intersection point P1 of the first efficiency curve C1 and the second efficiency curve C2, the circuit inductance curve C3 maintains at the first inductance Id1, and the corresponding efficiency curve is the first efficiency curve C1.

When the buck circuit 300 is in the state of heavy load, indicating that the current IL flowing through the inductor region 310 is greater than the current value Ith of the efficiency curve intersection point P1 of the first efficiency curve C1 and the second efficiency curve C2, due to the second inductor element L2 in the first inductor group 312 converting to a resistive element, the circuit inductance curve C3 will drop and convert to the second inductance Id2, and the corresponding efficiency curve changes to the second efficiency curve C2. Based on the above circuit configuration, regardless of whether the buck circuit 300 is in the state of light load or heavy load, the corresponding efficiency curve is always the one with higher efficiency value (indicated by solid line). Therefore, the energy consumption of the circuit under light load and heavy load can be reduced simultaneously, thereby significantly improving the circuit efficiency.

On the other hand, the horizontal axis of FIG. 6B represents the current value flowing through the inductor region 310, and the vertical axis represents the output voltage Vout at the output terminal OUT of the buck circuit 300. When the buck circuit 300 is in the state of light load, due to the larger circuit inductance, the width of the ripple waveform of the output voltage Vout is wider. When the buck circuit 300 is in the state of heavy load, due to the smaller circuit inductance, the width of the ripple waveform of the output voltage Vout is narrower.

In the above embodiments, the first inductor group 312 included in the planned inductor region 310 is formed by packaging after series connection of the first inductor element L1 and the second inductor element L2, but the disclosure may not be limited to this. Those skilled in the art may, according to their actual requirements and with reference to the teachings of this embodiment, extrapolate the number of inductor elements within the inductor group to more based on the analysis results of more efficiency curves.

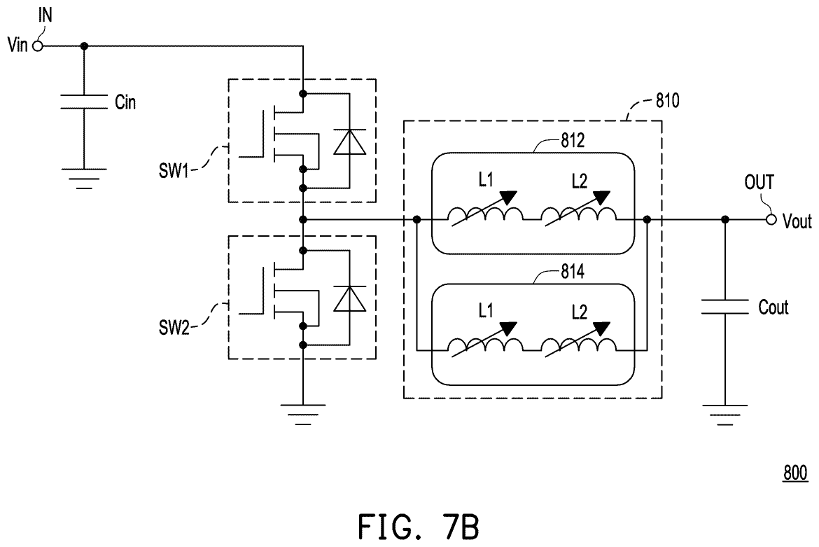

In addition, in other embodiments of the disclosure, those skilled in the art may, according to their actual requirements and with reference to the teachings of this embodiment, plan an inductor region including multiple inductor groups that are in series connection or parallel connection with each other. For example, in FIG. 7A, a buck circuit 700 includes an input capacitor Cin, a first switch SW1, a second switch SW2, an inductor region 710, and an output capacitor Cout. The inductor region 710 is coupled between the second terminal of the first switch SW1 and an output terminal OUT of the buck circuit 700, including a first inductor group 712 and a second inductor group 714. The first inductor group 712 and the second inductor group 714 are in series connection with each other. When the buck circuit 700 is in the state of light load, the circuit inductance of the buck circuit 700 equates to the sum of the inductance value of a first inductor element L1 in the first inductor group 712 and the second inductor group 714, and the inductance value of a second inductor element L2 in the first inductor group 712 and the second inductor group 714.

When the buck circuit 700 is in the state of heavy load, the second inductor element L2 in the first inductor group 712 and the second inductor group 714 converts to a resistive element. At this time, the circuit inductance of the buck circuit 700 equates to the sum of the inductance value of the first inductor element L1 in the first inductor group 712 and the second inductor group 714.

In FIG. 7B, a buck circuit 800 includes an input capacitor Cin, a first switch SW1, a second switch SW2, an inductor region 810, and an output capacitor Cout. The inductor region 810 is coupled between the second terminal of the first switch SW1 and the output terminal OUT of the buck circuit 800 and includes a first inductor group 812 and a second inductor group 814. The first inductor group 812 and the second inductor group 814 are in parallel connection with each other. The circuit inductance formed by the inductor region 810 may also change according to the status of the buck circuit 800. Therefore, whether it is a series inductor circuit or a parallel inductor circuit, both may be widely applied by the disclosure.

In practical applications, although the appearance of the inductor region of the disclosure is also a single structure inductor (which may occupy a relatively small space), its internal architecture may be composed of two or more inductor elements with different characteristics, having multi-stage inductance and multiple characteristics.

In summary, the circuit configuration device and method of the disclosure may enable the planned buck circuit to achieve relatively high efficiency values whether it is in the state of light load or heavy load. As a result, it may simultaneously reduce the energy consumption of the circuit under light load and heavy load, thereby significantly improving circuit efficiency, and further complying with energy regulations.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A circuit configuration device, applicable for configuring a buck circuit, the circuit configuration device comprising:
a storage device, configured to store a design specification of the buck circuit; and
a circuit configuration processor, coupled to the storage device, configured to load the design specification to execute:
evaluating an inductance range suitable for the buck circuit according to the design specification;
testing a plurality of efficiency curves respectively corresponding to a plurality of inductance values in the inductance range according to the design specification and the inductance range;
analyzing the efficiency curves to obtain one or more efficiency curve intersection points; and
planning an inductor region to be configured on the buck circuit according to the inductance range and the one or more efficiency curve intersection points,
wherein, the inductor region comprises one or more inductor groups, each of the one or more inductor groups is formed by packaging after series connection of a plurality of inductor elements, a circuit inductance formed by the inductor region varies with a state of the buck circuit.

2. The circuit configuration device according to claim 1, wherein the buck circuit comprises:
an input capacitor, wherein a first terminal of the input capacitor is coupled to an input terminal of the buck circuit, and a second terminal of the input capacitor is grounded;
a first switch, wherein a first terminal of the first switch is coupled to the input terminal of the buck circuit,
a second switch, wherein a first terminal of the second switch is coupled to a second terminal of the first switch, and a second terminal of the second switch is grounded;
the inductor region, coupled between the second terminal of the first switch and an output terminal of the buck circuit; and
an output capacitor, wherein a first terminal of the output capacitor is coupled to the output terminal of the buck circuit, and a second terminal of the output capacitor is grounded.

3. The circuit configuration device according to claim 1, wherein the each of the one or more inductor groups comprises a first inductor element and a second inductor element, a specification value of the second inductor element is greater than a specification value of the first inductor element.

4. The circuit configuration device according to claim 3, wherein the inductor region comprises a first inductor group, when the buck circuit is in a state of light load, the circuit inductance equates to a sum of an inductance value of the first inductor element in the first inductor group and an inductance value of the second inductor element in the first inductor group.

5. The circuit configuration device according to claim 4, wherein when the buck circuit is in a state of heavy load, the second inductor element in the first inductor group converts to a resistive element, the circuit inductance equates to the inductance value of the first inductor element in the first inductor group.

6. The circuit configuration device according to claim 5, wherein the efficiency curves comprise a first efficiency curve and a second efficiency curve, the first efficiency curve corresponds to the sum of the inductance value of the first inductor element in the first inductor group and the inductance value of the second inductor element in the first inductor group, the second efficiency curve corresponds to the inductance value of the first inductor element in the first inductor group, the buck circuit being in the state of light load indicates that a current flowing through the inductor region is less than a current value at an efficiency curve intersection point of the first efficiency curve and the second efficiency curve, the buck circuit being in the state of heavy load indicates that the current flowing through the inductor region is greater than the current value at the efficiency curve intersection point of the first efficiency curve and the second efficiency curve.

7. The circuit configuration device according to claim 3, wherein the inductor region comprises a first inductor group and a second inductor group, the first inductor group and the second inductor group are in series connection with each other, when the buck circuit is in a state of light load, the circuit inductance equates to a sum of an inductance value of the first inductor element in the first inductor group and the second inductor group and an inductance value of the second inductor element in the first inductor group and the second inductor group.

8. The circuit configuration device according to claim 7, wherein when the buck circuit is in a state of heavy load, the second inductor element in the first inductor group and the second inductor group convert to a resistive element, the circuit inductance equates to a sum of the inductance value of the first inductor element in the first inductor group and the second inductor group.

9. A circuit configuration method, applicable to a buck circuit, the circuit configuration method comprising:
evaluating an inductance range suitable for the buck circuit according to a design specification of the buck circuit;
testing a plurality of efficiency curves respectively corresponding to a plurality of inductance values in the inductance range according to the design specification and the inductance range;
analyzing the efficiency curves to obtain one or more efficiency curve intersection points; and
planning an inductor region to be configured on the buck circuit according to the inductance range and the one or more efficiency curve intersection points,
wherein, the inductor region comprises one or more inductor groups, each of the one or more inductor groups is formed by packaging after series connection of a plurality of inductor elements, a circuit inductance formed by the inductor region varies with a state of the buck circuit.

10. The circuit configuration method according to claim 9, wherein the buck circuit comprises:
an input capacitor, wherein a first terminal of the input capacitor is coupled to an input terminal of the buck circuit, and a second terminal of the input capacitor is grounded;
a first switch, wherein a first terminal of the first switch is coupled to the input terminal of the buck circuit,
a second switch, wherein a first terminal of the second switch is coupled to a second terminal of the first switch, and a second terminal of the second switch is grounded;
the inductor region, coupled between the second terminal of the first switch and an output terminal of the buck circuit; and
an output capacitor, wherein a first terminal of the output capacitor is coupled to the output terminal of the buck circuit, and a second terminal of the output capacitor is grounded.

11. The circuit configuration method according to claim 9, wherein the each of the one or more inductor groups comprises a first inductor element and a second inductor element, a specification value of the second inductor element is greater than a specification value of the first inductor element.

12. The circuit configuration method according to claim 11, wherein the inductor region comprises a first inductor group, when the buck circuit is in a state of light load, the circuit inductance equates to a sum of an inductance value of the first inductor element in the first inductor group and an inductance value of the second inductor element in the first inductor group.

13. The circuit configuration method according to claim 12, wherein when the buck circuit is in a state of heavy load, the second inductor element in the first inductor group converts to a resistive element, the circuit inductance equates to the inductance value of the first inductor element in the first inductor group.

14. The circuit configuration method according to claim 13, wherein the efficiency curves comprise a first efficiency curve and a second efficiency curve, the first efficiency curve corresponds to the sum of the inductance value of the first inductor element in the first inductor group and the inductance value of the second inductor element in the first inductor group, the second efficiency curve corresponds to the inductance value of the first inductor element in the first inductor group, the buck circuit being in the state of light load indicates that a current flowing through the inductor region is less than a current value at an efficiency curve intersection point of the first efficiency curve and the second efficiency curve, the buck circuit being in the state of heavy load indicates that the current flowing through the inductor region is greater than the current value at the efficiency curve intersection point of the first efficiency curve and the second efficiency curve.

15. The circuit configuration method according to claim 11, wherein the inductor region comprises a first inductor group and a second inductor group, the first inductor group and the second inductor group are in series connection with each other, when the buck circuit is in a state of light load, the circuit inductance equates to a sum of an inductance value of the first inductor element in the first inductor group and the second inductor group and an inductance value of the second inductor element in the first inductor group and the second inductor group.

16. The circuit configuration method according to claim 15, wherein when the buck circuit is in a state of heavy load, the second inductor element in the first inductor group and the second inductor group convert to a resistive element, the circuit inductance equates to a sum of the inductance value of the first inductor element in the first inductor group and the second inductor group.
